(19) United States
(12) Patent Application Publication
(10) Pub. No.: US 2015/0277976 A1
(43) Pub. Date: Oct. 1, 2015

(54) SYSTEM AND METHOD FOR DATA QUALITY ASSESSMENT IN MULTI-STAGE MULTI-INPUT BATCH PROCESSING SCENARIO

(71) Applicant: Anindito De, Chennai (IN)

(72) Inventor: Anindito De, Chennai (IN)

(73) Assignee: WIPRO LIMITED, Bangalore (IN)

(21) Appl. No.: 14/290,007

(22) Filed: May 29, 2014

(30) Foreign Application Priority Data
Mar. 25, 2014 (IN) 1586/CHE/2014

(51) Int. Cl. G06F 9/48; G06F 9/46

(52) U.S. Cl. CPC G06F 9/4881; G06F 9/466

(57) ABSTRACT

The present disclosure relates to systems, methods, and non-transitory computer-readable media for assessing data quality in multi-stage, multi-source batch processes that do not require validation of input data prior to processing. Embodiments of the present disclosure are further capable of identifying or predicting potential data quality issues, assessing their impact (if any) on the batch process, and providing recommendations for preventing or resolving the identified or predicted data quality issues.

This U.S. patent application claims priority under 35 U.S.C. §119 to Indian Patent Application No. 1586/CHE/2014, filed Mar. 25, 2014, and entitled “SYSTEM AND METHOD FOR DATA QUALITY ASSESSMENT IN MULTI-STAGE MULTI-INPUT BATCH PROCESSING SCENARIO,” The aforementioned application is incorporated herein by reference in its entirety.

### BACKGROUND

Batch processes are used by many large enterprises to efficiently handle a variety of data transactions often critical for business or regulatory purposes. Batch processes may be organized as a collection of batch jobs that perform a set of operations on discrete data sets to yield processed results. For example, a batch process for closing a financial cycle for a given business may require processing of numerous account payable transactions spread across different departmental units. The batch process for closing the financial cycle may include a batch job for each departmental unit handling the account payable transactions in the departmental unit. Each batch job processing account payable transactions may be further broken into steps that include reading the input account payable transaction from a database, processing the account payable transaction, and storing the processed account payable transaction in the same database or a different database. Upon completion of the batch jobs for the departmental units, the batch process may comprise another batch job that collects the processed account payable transactions from each departmental unit and produces an account summary that may be posted into a general ledger to close the financial cycle.

The foregoing description exemplifies a multi-stage, multi-source batch process in which batch jobs of the multistage, multi source batch process may be executed concurrently (the batch jobs processing the account transactions in a departmental unit) or sequentially (the batch job collecting the processed account payable transactions from each departmental unit), and in which input data to the batch process is supplied from different sources and/or at different stages in the batch process. Stages in a multi-stage, multi-source batch process may correspond to a temporal sequence of execution, where batch jobs belonging to different stages may be executed at different times in a particular order. Stages in a multi-stage, multi-source batch process may also correspond to dependences between batch jobs, where input data to a later-executed batch job depends on the output data of an earlier-executed batch job. Generally, batch jobs belonging to the same stage of a multi-stage batch process may be executed either sequentially or concurrently, and the overall efficiency of the batch process may be substantially improved by concurrently executed batch jobs belonging to the same stage. Input data to a multi-stage, multi-source batch process may be obtained from multiple sources (e.g., different business departments) or at different stages of execution. For example, batch jobs processing account payable transactions for different business departments may belong to a first stage in a batch process for closing a customer account. A batch job processing account payable transaction for one business department may obtain unprocessed transactions from a different source than a batch job processing account payable transactions in another department. The batch process may comprise a second stage, executed after the batch jobs in the first stage complete execution, comprising a batch job that collects the processed account payable transactions and further obtains customer account information to produce an account summary that may be used to update a general ledger.

Multi-stage, multi-source batch processes, however, implicate several technical difficulties due to complex dependencies between batch jobs. To ensure integrity and efficiency of a batch process, it is necessary to ensure that input data to the batch process satisfies certain quality standards. For example, input data to a batch job may be required to conform to a number of data formatting rules and/or file formats (e.g., comma-separated values, tab-separated values, proprietary file formats, etc.). Batch jobs may also require input data to fall within certain value ranges or to satisfy certain relationships. Data quality may be influenced by hardware failure, data corruption, new business process changes and new business environment changes, etc. For example, a sudden spike of a particular type of transaction in a short time period may cause downstream batch jobs to stall as they wait for upstream batch jobs complete execution. Failure of input data to satisfy the requisite quality standard may result in minor issues such as slowdown of the multi-stage, multi-source batch process, but may also result in more serious issues such as failure or stalling of a batch job in the batch process, failure of the batch process to complete within a certain expected time period, or failure of the batch process as a whole. The magnitude of impact of poor data quality may further depend on the structure of the batch process as problems occurring in earlier stages may have a greater impact on the batch process than problem occurring in later stages if the batch jobs in later stages rely on output produced by batch jobs in earlier stages.

One solution to the problem of data quality is to validate input data prior to its being processed. Thus, prior to being provided to the batch process or a batch job in a batch process, the data is first examined to ensure that that satisfies the relevant quality standard. However, validation of input data for large or numerous data sets may require significant computing time on top of the computing time necessary to actually process the input data. Validation of input data itself may require a batch process, thus creating yet another source of error or processing complexity. Moreover, validation of input data by itself only confirms the possibility of a data quality issue and does not provide any assessment of how the data quality issue may impact operation of the batch process. Accordingly, the predictive value of validating input data prior to processing is very low. The predictive value of validating input data prior to processing is further reduced by complex dependencies between batch jobs and/or stages in a mutli-stage, multi-source batch process, as merely validating input data provides no measure of upstream or downstream effects.

Embodiments of the present disclosure provide systems, methods, and non-transitory computer-readable media for assessing data quality in multi-stage, multi-source batch processes that do not require validation of input data prior to processing. Embodiments of the present disclosure are further capable of identifying or predicting potential data quality issues, assessing their impact (if any) on the batch process, and providing recommendations for preventing or resolving the identified or predicted data quality issues.

### SUMMARY

Embodiments in accordance with the present disclosure relate to a method for assessing data quality in a multi-stage, multi-source batch process, the batch process including one or more batch jobs being concurrently executed by one or more hardware processors. The method may comprise determining, by one or more hardware processors, a performance parameter associated with the one or more batch jobs from a set of batch process parameters based on metadata associated with the batch process. The method may also include monitoring a real-time value associated with the performance parameter during execution of the batch process and calculating a deviation of the monitored real-time value associated with the performance parameter from a threshold value associated with the performance parameter. The method may also include predicting, by one or more hardware processors, that one or more data quality issues are present and a magnitude of the one or more data quality issues based on the calculated deviation and a correlation between the calculated deviation and one or more previously identified potential data quality issues. The method may further include predicting, by one or more hardware processors, a magnitude of an impact of the one or more predicted data quality issues on the batch process, and providing, by one or more hardware processors, a recommendation to resolve the one or more predicted data quality issues. The set of batch process parameters may include at least one of: a frequency or number of transactions processed in a logical path within a batch job from among the one or more batch jobs, a number of read/write operations performed by a batch job from among the one or more batch jobs on a dataset, time taken to execute a step within a batch job from among the one or more batch jobs, or a frequency or number of failed transactions within a batch job from among the one or more batch jobs. In certain embodiments, the performance parameter may comprise a vector of two or more performance parameters associated with the one or more batch jobs, such that monitoring the real-time value associated with the performance parameter during execution of the batch process may comprise determining a vector of real-time values associated with the two or more performance parameters, and calculating a deviation of the monitored real-time value may comprise calculating a vector difference between the vector of real-time values and a vector of threshold values associated with the performance parameter. Thus, predicting that one or more data quality issues are present may comprise making the prediction based on the vector difference and a correlation between the vector difference and one or more previously identified data quality issues.

In certain embodiments, the method may further comprise calibrating the threshold value associated with the performance parameter and/or the correlation between the calculated deviation and the one or more previously identified data quality issues. Calibration may occur when performance of the batch process does not match an expected performance of the batch process. In certain embodiments of the method may comprise providing an assessment of impacts on the batch process based on the one or more predicted data quality issues and metadata associated with the batch process. In certain embodiments, the method may comprise receiving, from an authenticated user, at least one of: the set of batch process parameters, the threshold value associated with the performance parameter, or the correlation between the calculated deviation and one or more previously identified potential data quality issues.

Embodiments in accordance with the present disclosure further relate to a system for assessing data quality in a multi-stage, multi-source batch process comprising one or more hardware processors and a computer-readable medium storing instructions that, when executed by the one or more hardware processors, cause the one or more hardware processors to perform operations. The operations may comprise determining a performance parameter associated with the one or more batch jobs from a set of batch process parameters based on metadata associated with the batch process. The operations may also comprise monitoring a real-time value associated with the performance parameter during execution of the batch process, and calculating a deviation of the monitored real-time value associated with the performance parameter from a threshold value associated with the performance parameter. The operations may also include predicting that one or more data quality issues are present and a magnitude of the one or more data quality issues based on the calculated deviation and a correlation between the calculated deviation and one or more previously identified potential data quality issues. The operations may also include predicting, by the one or more hardware processors, a magnitude of an impact of the one or more predicted data quality issues on the batch process, and providing a recommendation to resolve the one or more predicted data quality issues. The set of batch process parameters may include at least one of: a frequency or number of transactions processed in a logical path within a batch job from among the one or more batch jobs, a number of read/write operations performed by a batch job from among the one or more batch jobs on a dataset, time taken to execute a step within a batch job from among the one or more batch jobs, or a frequency or number of failed transactions within a batch job from among the one or more batch jobs. In certain embodiments, the performance parameter may comprise a vector of two or more performance parameters associated with the one or more batch jobs, such that monitoring the real-time value associated with the performance parameter during execution of the batch process may comprise determining a vector of real-time values associated with the two or more performance parameters, and calculating a deviation of the monitored real-time value may comprise calculating a vector difference between the vector of real-time values and a vector of threshold values associated with the performance parameter. Thus, predicting that one or more data quality issues are present may comprise making the prediction based on the vector difference and a correlation between the vector difference and one or more previously identified data quality issues.

In certain embodiments, the operations may further comprise calibrating the threshold value associated with the performance parameter and/or the correlation between the calculated deviation and the one or more previously identified data quality issues. Calibration may occur when performance of the batch process does not match an expected performance of the batch process. In certain embodiments, the operations may further comprise providing an assessment of impacts on the batch process based on the one or more predicted data quality issue and metadata associated with the batch process. In certain embodiments, the operations may further comprise receiving, from an authenticated user, at least one of: the set of batch process parameters, the threshold value associated with the performance parameter, or the correlation between the calculated deviation and one or more previously identified potential data quality issues.

Embodiments in accordance with the present disclosure also relate to a non-transitory computer-readable medium storing instructions for assessing data quality in a multi-stage, multi-source batch process, wherein upon execution of the instructions by one or more hardware processors, the hardware processors perform operations. The operations may comprise determining a performance parameter associated with the one or more batch jobs from a set of batch process parameters based on metadata associated with the batch process. The operations may also include monitoring a real-time value associated with the performance parameter during execution of the batch process, and calculating a deviation of the monitored real-time value associated with the performance parameter from a threshold value associated with the performance parameter. The operations may further include predicting that one or more data quality issues are present and a magnitude of the one or more data quality issues based on the calculated deviation and a correlation between the calculated deviation and one or more previously identified potential data quality issues, and predicting, by the one or more hardware processors, a magnitude of an impact of the one or more predicted data quality issues on the batch process. The operations may also comprise providing a recommendation to resolve the one or more predicted data quality issues. The set of batch process parameters may include at least one of: a frequency or number of transactions processed in a logical path within a batch job from among the one or more batch jobs, a number of read/write operations performed by a batch job from among the one or more batch jobs on a dataset, time taken to execute a step within a batch job from among the one or more batch jobs, or a frequency or number of failed transactions within a batch job from among the one or more batch jobs. In certain embodiments, the performance parameter may comprise a vector of two or more performance parameters associated with the one or more batch jobs, such that monitoring the real-time value associated with the performance parameter during execution of the batch process may comprise determining a vector of real-time values associated with the two or more performance parameters, and calculating a deviation of the monitored real-time value may comprise calculating a vector difference between the vector of real-time values and a vector of threshold values associated with the performance parameter. Thus, predicting that one or more data quality issues are present may comprise making the prediction based on the vector difference and a correlation between the vector difference and one or more previously identified data quality issues.

In certain embodiments, the operations may further comprise calibrating the threshold value associated with the performance parameter and/or the correlation between the calculated deviation and the one or more previously identified data quality issues. Calibration may occur when performance of the batch process does not match an expected performance of the batch process. In certain embodiments, the operations may further comprise providing an assessment of impacts on the batch process based on the one or more predicted data quality issue and metadata associated with the batch process. In certain embodiments, the operations may further comprise receiving, from an authenticated user, at least one of: the set of batch process parameters, the threshold value associated with the performance parameter, or the correlation between the calculated deviation and one or more previously identified potential data quality issues.

Additional objects and advantages of the present disclosure will be set forth in part in the following detailed description, and in part will be obvious from the description, or may be learned by practice of the present disclosure. The objects and advantages of the present disclosure will be realized and attained by means of the elements and combinations particularly pointed out in the appended claims.

### BRIEF DESCRIPTION OF THE DRAWINGS

The accompanying drawings, which constitute a part of this specification, illustrate several embodiments and, together with the description, serve to explain the disclosed principles. In the drawings:

FIG. 1 is a block diagram of a high-level architecture of an exemplary system in accordance with the present disclosure;

FIG. 2 is a flowchart of an exemplary method for assessing data quality in a multi-stage, multi-source batch process in accordance with the present disclosure; and

FIG. 3 is a block diagram of an exemplary computer system for implementing embodiments consistent with the present disclosure

### DETAILED DESCRIPTION

As used herein, reference to an element by the indefinite article “a” or “an” does not exclude the possibility that more than one of the element is present, unless the context clearly requires that there is one and only one of the elements. The indefinite article “a” or “an” thus usually means “at least one.” The disclosure of numerical ranges should be understood as referring to each discrete point within the range, inclusive of endpoints, unless otherwise noted.

As used herein, the terms “comprise,” “comprises,” “comprising,” “includes,” “including,” “has,” “having,” “contains,” or “containing,” or any other variation thereof, are intended to cover a nonexclusive inclusion. For example, a composition, process, method, article, system, apparatus, etc. that comprises a list of elements is not necessarily limited to only those elements but may include other elements not expressly listed. The terms “consist of,” “consists of,” “consisting of,” or any other variation thereof, excludes any element, step, or ingredient, etc., not specified. The term “consist essentially of,” “consists essentially of,” “consisting essentially of,” or any other variation thereof, permits the inclusion of elements, steps, or ingredients, etc., not listed to the extent they do not materially affect the basic and novel characteristic(s) of the claimed subject matter.

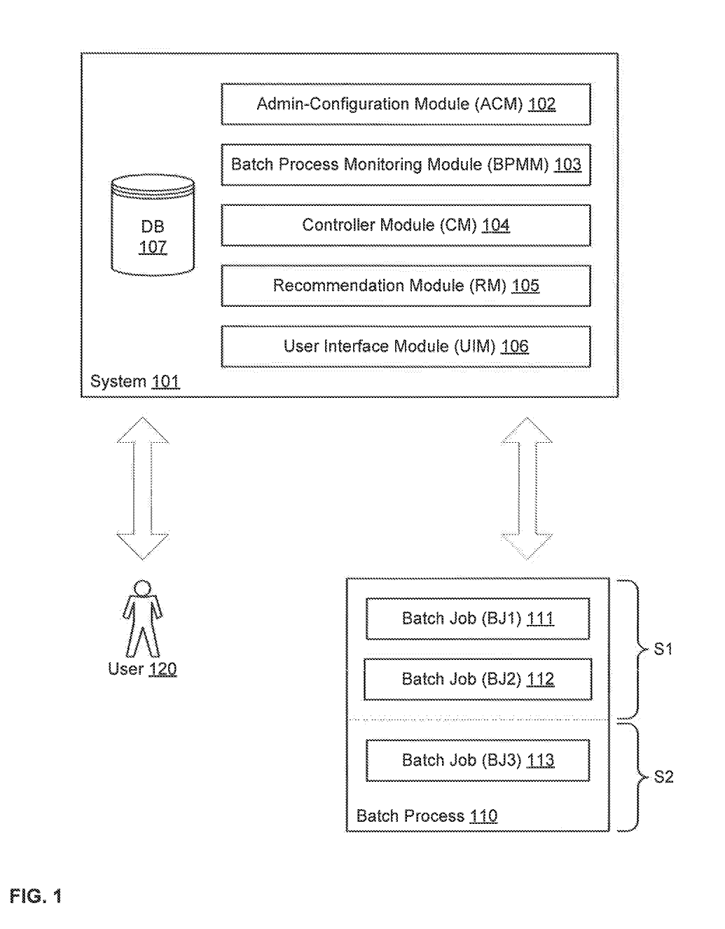

FIG. 1 is a block diagram of a high-level architecture of an exemplary system 101 for assessing data quality in a batch process 110 in accordance with the present disclosure comprising an Admin-Configuration Module (ACM) 102, a Batch Process Monitoring Module (BPMM) 103, a Controller Module (CM) 104, a Recommendation Module (RM) 105, a User Interface Module (UIM) 106 and a database 107. The disclosed modules may be implemented in software, hardware, firmware, or any combination thereof. System 101 may also communicate with a user 120. The architecture shown in FIG. 1 may be implemented using one or more hardware processors (not shown), and a computer-readable medium storing instructions (not shown) configuring the one or more hardware processors; the one or more hardware processors and the computer-readable medium may also form part of the system 101.

Batch process 110 may be a multi-stage, multi-source batch process in which case, as shown in FIG. 1, batch process 110 may comprise two or more batch jobs (e.g., BJ1 111, BJ2 112, and BJ3 113 as shown in FIG. 1), which may be divided into stages (e.g., S1 and S2, as shown in FIG. 1). A batch job may receive input data from other batch jobs or different sources. Batch jobs within a stage may have a common classification or grouping, and may run in parallel or sequentially depending on logical relationships among the batch jobs. Thus, as shown in FIG. 1, BJ1 111 and BJ2 112 may be concurrently executed. Batch jobs belonging to different stages may run in a sequential manner. Thus, as shown in FIG. 1, BJ3 113 may be executed upon completion of BJ1 111 and BJ2 112.

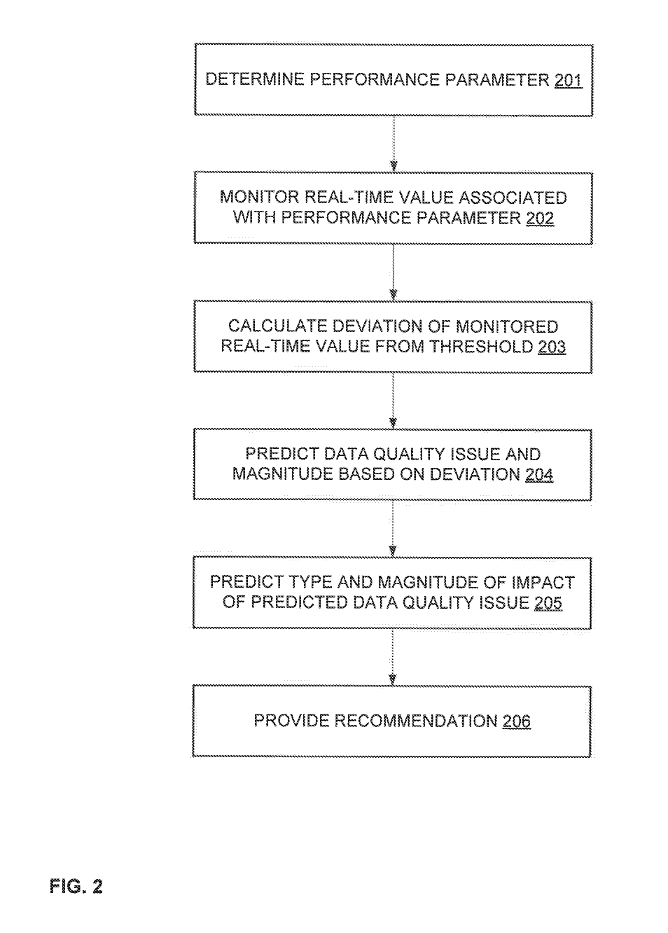

FIG. 2 is flowchart of an exemplary method for assessing data quality in a multi-stage, multi-source batch process in accordance with the present disclosure. The method of FIG. 2 may be executed by, for example, system 101 shown in FIG. 1. Though the following description provides an embodiment in which various steps of the method shown in FIG. 2 are performed by certain modules of system 101, it is noted such features and functions may be provided by different modules and/or Implementations without departing from the scope of the present disclosure.

### System Configuration and Batch Process Monitoring

As shown in step 201 of FIG. 2, a method in accordance with the present disclosure may include determining a performance parameter associated with the one or more batch jobs from a set of batch process parameters based on metadata associated with the batch process. Determining the performance parameter may comprise initializing system 101 with information comprising supported batch job types, supported performance parameters and corresponding supported performance parameter threshold values, classification levels for deviations between supported performance parameters and corresponding threshold values, correlation information, and/or recommendation information, and configuring system 101 using metadata associated with batch process 110.

Supported batch jobs types relate to the types of batch jobs that system 101 may monitor to assess data quality. The type of a batch job may be defined by, for example, input-output behavior of the batch job (such as the location to which input data is read or where processed data is stored, the type of input or output data (e.g., file format) accepted or produced by the batch job, manner of processing input data by the batch job, an identifier of the batch job, classification of the batch job by business use, performance parameters of the batch that may be monitored, etc.

Supported performance parameters relate to performance parameters associated with real-time values that may be monitored by system 101. For example, system 101 may have permission to monitor read/write operations in a certain portion of an organization's information technology infrastructure, e.g., a particular database. Accordingly a supported performance of system 101 may be a number or frequency of read/write operations performed by a batch job in that database. Generally, batch jobs may comprise one or more logical paths that perform transactions that may be monitored by system 101. Supported performance parameters may relate to the type of transaction that system 101 is capable of monitoring. Supported performance parameters may include, for example, a number or frequency of transactions processed in a logical path of a batch job (e.g., mathematical operations, read operations, write operations, etc.), a number or frequency of read/write operations made from/to certain data storage locations (e.g., different files and/or tables stored within the organization's information technology infrastructure), an amount of time (e.g., computing time) taken by a step or operation of a batch job, a number or frequency of failed transactions (e.g., failed read/write operations) by a batch job or a logical path of a batch, etc. Thus, for example, a performance parameter for a batch job processing account payable transactions may include a number, frequency, etc. of read operations made from a table storing unprocessed account payable transactions, a number or frequency of storage or memory reallocations, an amount of time used to process a single account payable transaction, a number or frequency of addition or subtraction operations performed, etc.

Each supported performance parameter corresponds to a supported performance parameter threshold value that provides a quantitative yardstick of batch process performance. When a real-time value associated with a performance parameter deviates from its corresponding performance parameter threshold value, system 101 may use the deviation (e.g., the magnitude of the deviation) to determine if a data quality issue is present in batch process 110, as well as a magnitude of the data quality issue. Thus, for example, system 101 may monitor a frequency of read/write operations made by a batch job BJ1 111 processing account payable transactions. In this example, if the monitored frequency value deviates from a threshold frequency of read/write operations value, system 101 may use the magnitude of the deviation to determine if a data quality issue is present in batch process 110. Similarly, system 101 may monitor an amount of time used by batch job BJ1 111 to process a single account payable and, if the monitored amount of time exceeds a threshold amount of time value, system 101 may use the magnitude of the deviation to determine if a data quality issue is present in batch process 110. A supported performance parameter threshold value may also correspond to one or more supported performance parameters, e.g., a function of one or more supported performance parameters.

Classification levels for deviations between supported performance parameters and corresponding performance parameter threshold values may be provided during initialization of system 101. Such classification levels may be based on the magnitude of the data quality issue and the classification levels may also have a priority—data quality issues having larger magnitudes may be classified as having to a higher priority level, while data quality issues having smaller magnitudes may be classified as having a lower priority level.

Correlation information may be used by system 101 to determine or predict if a data quality issue is or will be present in batch process 110 based on, for example: deviations between supported performance parameters and corresponding performance parameter threshold values and/or classification levels for deviations between supported performance parameters and corresponding performance parameter threshold values. Correlation information may comprise one or more correlation functions that, based on one or more deviations and/or one or more classification levels, determine or predict the likelihood that a particular data quality issue is present using, for example, a mathematical correlation, a probability density function, and/or a statistical test. Correlation information may also be used by system 101 to determine or predict the magnitude of the predicted or determined data quality issue based on, for example, deviations between supported performance parameters and corresponding performance parameter threshold values and/or classification levels for deviations between supported performance parameters and corresponding performance parameter threshold values.

Correlation information may also be used by system 101 to determine or predict a magnitude of impact of data quality issues on performance of the batch process 110 based on the likelihood that certain data quality issues are present. Thus, correlation information may comprise one or more correlation functions that, based on one or more probabilities that one or more data quality issues are present, the types of data quality issues that are present, and/or one or more magnitudes of the one or more data quality issues, determines or predicts a likely magnitude of impact using, for example, a mathematical correlation, a probability density function, and/or a statistical test. A magnitude of an impact of a data quality issue on performance of batch process 110 may include, for example, a likelihood that a batch process 110 will not terminate within a certain amount of time, an amount of time needed for batch process 110 to terminate, a number or proportion of batch jobs of batch process 110 that will fail or succeed, a coded warning or alert (e.g., a green, yellow, or red alert) indicating the seriousness the impact, etc.

Recommendation information may be used by system 101 to provide a recommendation to resolve a determined or predicted data quality issue based on data quality issues determined or predicted by system 101, types of data quality issues determined or predicted by system 101, and/or magnitudes of impacts of data quality issues on performance of batch process 110. Recommendation information may comprise one or more correlation functions that, based on data quality issues determined or predicted by system 101, types of data quality issues determined or predicted by system 101, and/or magnitudes of impacts of data quality issues on performance of batch process 110, determine that a particular recommendation should be provided using, for example, a mathematical correlation, a probability density function, and/or a statistical test.

Initializing system 101 may be performed by Admin-Configuration Module (ACM) 102, shown in FIG. 1, which may receive information comprising supported batch job types, supported performance parameters and corresponding supported performance parameter threshold values, classification levels for deviations between supported performance parameters and corresponding threshold values, correlation information, and/or recommendation information from a user 120. ACM 102 may receive information via, for example, User Interface Module (UIM) 106, which may include a human-machine interface capable of receiving input from user 120, for example a graphical user interface (GUI) and/or other I/O devices (e.g., an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, visors, printer, fax machine, video display (e.g., cathode ray tube (CRT), liquid crystal display (LCD), light-emitting diode (LED), plasma, or the like), audio speaker, etc.). In certain embodiments, ACM 102 may authenticate user 120 prior to receiving information from or providing information to user 120 via UN 106. ACM 102 may store information received during initialization of system 101 as metadata in database 107. Thus database 106 may store supported batch job type metadata, supported performance parameters metadata and corresponding supported performance parameter threshold values metadata, classification level metadata for deviations between supported performance parameters and corresponding threshold values, correlation information metadata, and/or recommendation information metadata.

Configuring system 101 based on metadata associated with batch process 110 may comprise determining a structure of batch process 110 based on information received by ACM 102 during the initialization of system 101 and metadata associated with batch process 110. Configuring system 101 may also include identifying which batch jobs in batch process 110 are supported by system 101 based on supported batch job types of system 101 and the determined structure of batch process 110, and determining one or more performance parameters associated with one or more batch jobs in batch process 110 based on supported performance parameters of system 101.

Metadata associated with a batch process may specify information regarding the structure of the batch process, comprising, for example, a number of batch jobs in the batch process, identifiers associated with batch jobs in the batch process, types of batch jobs in the batch process, a number and/or an order of stages in the batch process, a distribution of batch jobs among stages of the batch process, input data sources for batch jobs in batch process, steps or operations performed by batch jobs in the batch process, output data produced by batch jobs in the batch process, dependencies between batch jobs, etc. Metadata associated with batch process 110 may be received by ACM 102 (e.g., received via UM 106 from a user 120 operating system ACM 102 consistent with disclosed embodiments) during configuration of system 101 or may be obtained from the runtime environment batch process 110. ACM 102 may use metadata associated with batch process 110 to determine a structure of batch process 110 based on information included in the metadata, ACM 102 may also determine a structure of batch process 110 based on information received during initialization of system 101 in addition to metadata associated with batch process 110. ACM 102 may store the determined structure of batch process 110 as structural metadata in database 107.

AMC 102 may identify which batch jobs in batch process 110 are supported by system 101 based on supported batch job types of system 101 and/or the determined structure of batch process 110 by, for example, searching and/or matching information received by ACM 102 during initialization of system 101 with the structural metadata of the determined structure of batch process 110 stored in database 107. For example, based on information received by ACM 102 during initialization, system 101 may support batch jobs that process account payable transactions. During configuration of system 101, ACM 102 may determine if any of the batch jobs in batch process 110 are batch jobs that process account payable transactions by searching and/or matching structural metadata of the determined structure of batch process 110 stored in database 107 with supported batch job type metadata also stored in database 107. ACM 102 may modify the structural metadata stored in database 107 to reflect whether a batch job in batch process 110 is supported by system 101.

ACM 102 may further determine one or more performance parameters associated with one or more batch jobs in batch process 110 based on supported performance parameters of system 101 by, for example, searching and/or matching information received by ACM 102 during initialization of system 101 with the structural metadata of the determined structure of batch process 110 stored in database 107. Determining the one or more performance parameters may also be based on the identification of supported batch jobs in batch process 110 system 101. For example, supported batch job type metadata may be associated with supported performance parameter metadata in database 106 based on information received by ACM 102 during initialization of system 101. Thus, determining one or more performance parameters associating with one or more batch jobs in batch process 110 based on supported performance parameters may comprise searching and/or matching structural metadata of the determined structure of batch process 110 stored in database 107 with the supported performance parameter metadata and/or supported batch job type metadata stored in database 107.

ACM 102 may store the determined one or more performance parameters in database 107. ACM 102 may associate each of the determined one or more performance parameters stored in database 107 with structural metadata of the determined structure of batch process 110. For example, ACM 102 may associate each performance parameter stored in database 107 with metadata in the structural metadata corresponding a batch job in batch process 110. Certain embodiments in accordance with the present disclosure may determine two or more performance parameters associated with the one or more batch jobs in batch process. In these cases, ACM 102 may store the determined two or more performance parameters as a vector of performance parameters in database 107. ACM 102 may also associate each of the determined one or more performance parameters with a threshold value using the supported performance parameter threshold value metadata stored in database 107. If two or more performance parameters are determined, ACM 102 may associate the vector of performance parameters with a vector of threshold values, wherein each performance parameter in the vector of performance parameters may be associated with a threshold value in the vector of threshold values.

Configuring system 101 using metadata associated with batch process 110 may further comprise configuring system 101 to monitor a real-time value associated with a determined performance parameter associated with batch process 110. For example, Controller Module (CM) 104 may configure Batch Process Monitoring Module (BPMM) 103 to monitor one or more real-time values associated with the determined one or more performance parameters based on structural metadata of the determined structure of batch process 110 stored in database 107 by ACM 102 and/or the determined one or more performance parameters stored in database 107. CM 104 thus may configure BPMM 103 to receive and/or obtain one or more real-time values associated with the determined one or more performance parameters associated with batch process 110 stored in database 107. CM 104 may also configure BPMM 103 based on supported performance parameter metadata stored in database 107.

As shown in step 202 of FIG. 2, system 101 may monitor real-time values associated with the determined one or more performance parameters. For example, BPMM 103 may be configured to monitor real-time values associated with a vector of performance parameters comprising a first frequency of read/write operations performed by BJ1 111 in batch process 110, a second frequency of read/write operations performed by BJ2 112 in batch process 110, and an amount time (e.g., computing time) used in a logical path of BJ3 113 in batch process 110. During execution of batch process 110, BPMM 103 may be configured to receive and/or access the real-time values from the runtime environment on batch process 110 or from metadata associated with batch process 110. BPMM 103 may be configured to monitor the real-time values on a periodic basis (e.g., for certain periods of time a certain frequencies and/or intervals). BPMM 103 may store the monitored real-time values as a vector of monitored real-time values in database 107. For example, BPMM 103 may append a vector of monitored real-time values to a table of historical real-time values stored in database 107.

### Prediction/Detection of Data Quality Issues and Magnitude of Data Quality Issues

Prediction and/or detection of a data quality issue and a magnitude of the data quality issue in batch process 110 may comprise, in accordance with certain embodiments of the present disclosure, calculating a deviation of the monitored real-time value associated with the performance parameter from a threshold value associated with the performance parameter, as shown in step 203 of FIG. 2, and predicting and/or detecting that one or more data quality issues are present and a magnitude of the one or more data quality issues based on the calculated deviation and a correlation between the calculated deviation and one or more previously identified potential data quality issues, as shown in step 204 of FIG. 2.

For example, Controller Module (CM) 102 may calculate a deviation between a monitored real-time value stored in database 107 by BPMM 103 and a threshold value associated with a performance parameter associated with the monitored real-time value stored in database 107 by ACM 102 during initialization of system 101. The deviation may comprise, for example, a difference obtained by subtracting the monitored real-time value from the threshold value. In certain embodiments, the threshold value may comprise a mean threshold value and threshold standard deviation, and the deviation may comprise the number of standard deviations away the monitored real-time value is from the mean threshold value.

Where BPMM 103 monitors two or more real-time values, CM 102 may calculate a deviation vector between a vector of monitored real-time values stored in database 107 by BPMM 103 and a vector of threshold values associated with a vector of performance parameters associated with the vector of monitored real-time value stored in database 107 by ACM 102 during initialization of system 101. The deviation vector may comprise a vector difference obtained by subtracting the vector of monitored real-time values from the vector of threshold values. In certain embodiments, a threshold value in the vector of threshold values may comprise a mean threshold value and threshold standard deviation, and the deviation vector comprises values corresponding to the number of standard deviations away a monitored real-time value in the vector of monitored real-time values is from the mean threshold value.

Based on the calculated deviation (or calculated deviation vector), CM 102 may predict and/or detect that one or more data quality issues is present and a magnitude of the one or more data quality issues based on, for example, correlation information metadata stored in database 107 by ACM 102 during initialization of system 101. CM 102 may determine if one or more data quality issues is present based on, for example, the one more correlation functions that, based on one or more deviations and/or one or more classification levels, determine or predict the likelihood that a particular data quality issue is present based on, for example, a mathematical correlation, a probability density function, and/or a statistical test.

For example, database 107 may store correlation information comprising a correlation function that, based on a deviation between a frequency of read/write operations performed by BJ1 111 in batch process 110 and a threshold frequency of read/write operations performed by BJ 111 in batch process 110, determines a probability that a profile of input data to BJ1 111 differs from a normal profile. Thus, to determine if input data to BJ1 111 has a different profile than normal and the magnitude of the difference, CM 102 may calculate a deviation between a monitored real-time value for the frequency of read/write operations performed by BJ1 111 stored in database 107 by BPMM 102 and a threshold value for the frequency of read/write operations performed by BJ1 111 stored in database 107 by ACM 102 during initialization of system 101. The deviation may comprise the difference between the real-time value and the threshold value obtained by subtracting the real-time value from the threshold value, CM 102 may then determine a probability that input data to BJ1 111 differs from a normal profile and magnitude of the difference based on the correlation function and the calculated deviation. If the probability that input data to BJ1 111 differs from a normal profile obtained based on the correlation function and the calculated deviation exceeds a certain probability threshold associated with the correlation function (e.g., 50%), CM 102 may determine that input data to BJ1 111 differs from a normal profile and may further determine a magnitude of the difference. CM 102 may store the one or more predicted and/or detected data quality issues and one or more magnitudes of the one or more data quality issues in database 107, for example, by storing predicted and/or detected data quality issues metadata in database 107 comprising, for each predicted and/or detected data quality issue, a probability that the data quality issue is present, a type of the data quality issue, and/or a magnitude of the data quality issue.

CM 102 may determine if one or more data quality issues are present and one or more magnitudes of the data quality issues by iterating over correlation functions in correlation information stored in database 107. In certain embodiments, CM 102 may iterate only over correlation functions in correlation information stored in database 107 that do not require calculation of a deviation based on a real-time value associated with a performance parameter not associated with one or more batch jobs in batch process 110. For these embodiments, ACM 102 may, after determining the one or more performance parameters associated with one or more batch jobs in batch process 110, identify which correlation functions in the correlation information stored in database 107 should not be iterated over based whether correlation function requires calculation a deviation based on a real-time value associated with a performance parameter not associated with one or more batch jobs in batch process 110.

### Assessment of Data Quality and Recommendation

As shown in step 205 of FIG. 2, system 101 may predict and/or determine a magnitude of an impact of the one or more predicted and/or detected data quality issues on the batch process. A magnitude of an impact of a data quality issue on performance of batch process 110 may include, for example, a likelihood that a batch process 110 will not terminate within a certain amount of time, an amount of time needed for batch process 110 to terminate, a number or proportion of batch jobs of batch process 110 that will fail or succeed, a coded warning or alert (e.g., a green, yellow, or red alert) indicating the seriousness the impact, etc.

CM 102 may predict and/or determine a magnitude of an impact of one or more predicted and/or detected data quality issues based on correlation information metadata stored in database 107 by ACM 102 during initialization of system 101. Correlation information stored in database 107 may comprise one or more correlation functions that, based on one or more probabilities that one or more data quality issues are present, the types of data quality issues that are present, and/or one or more magnitudes of the one or more data quality issues, determines a likely magnitude of impact using, for example, a mathematical correlation, a probability density function, and/or a statistical test. CM 102 may determine one or more magnitudes of impacts by iterating over one or more correlation functions stored in database 107. For example, database 107 may store predicted and/or detected data quality issues metadata comprising a predicted data quality issue comprising a first probability that a profile of input data to BJ1 111 in batch process 110 differs from a normal profile. The metadata may further comprise another predicted data quality issue comprising a second probability that a profile of input data to BJ3 113 in batch process 110 differs from a normal profile. CM 102 may predict and/or determine a first magnitude of the impact of input data to BJ1 111 having a different profile and input data to BJ3 113 having a different profile based on a first correlation function in correlation information stored in database 107 that determines, based on the first probability and second probability, that batch process 110 will fail to complete execution within a certain period of time. CM 102 may predict a second magnitude of the impact of input data to BJ1 111 having a different profile and input data to BJ3 113 having a different profile based on a second correlation function in correlation information stored in database 107 that determines, based on the first probability and second probability, a likelihood that batch process 110 will fail to complete execution within a certain period of time. CM 103 may predict a third magnitude of the impact of input data to BJ1 111 having a different profile and input data to BJ3 113 having a different profile based on a third correlation function in correlation information stored in database 107 that determines, based on the first probability and second probability, an additional amount of time that batch process 110 will require to complete execution. CM 102 may store the predicted and/or determined one or more magnitudes of impact in database 107, for example, by storing predicted and/or determined magnitude of impact metadata in database 107 comprising, for each predicted and/or determined magnitude of impact, a value of the magnitude of impact and/or type of magnitude of impact.

In certain embodiments, CM 102 may also determine a magnitude of impact of one or more predicted and/or detected data quality issues based on the structure of batch process 110. For example, CM 102 may determine a magnitude impact based on structural metadata of the determined structure of batch process 110 stored in database 107, by ACM 102 during configuration of system 101. CM 102 may further determine a magnitude of impact based on a correlation function in correlation information that determines, based on the structural metadata of the determined structure of batch process 110 and one or more predicted and/or detected data quality issues in the predicted and/or detected data quality issues metadata stored in database 107, a magnitude of impact of the one or more predicted and/or detected data quality issues on batch process 110.

In step 206 as shown in FIG. 2, system 101 may provide a recommendation to resolve the one or more predicted and/or detected data quality issues. Thus, Recommendation Module (RM) 105 of system 101 shown in FIG. 1 may determine one or more recommendations to provide based on one or more correlation functions in recommendation information stored in database 107 that determine, based on one or more predicted and/or detected data quality issues metadata, one or more types of predicted and/or detected data quality issues metadata, one or more magnitude of predicted and/or detected data quality issues metadata, and/or one or more magnitudes of impact of predicted and/or detected data quality issues, that a particular recommendation should be provided, using, for example, a mathematical correlation, a probability density function, and/or a statistical test. Thus, for example, RM 105 may determine whether to provide a recommendation that input data to BJ1 111 in batch process 110 should be validated based on a correlation function stored in database 107 that determines, based on predicted and/or detected data quality issue metadata stored in database 107 comprising a probability that a profile input data to BJ1 111 in batch process 110 differs from a normal profile, and magnitude of impact metadata stored in database 107 comprising a value for a predicted and/or determined magnitude of impact of input data to BJ1 111 having a different profile on batch process 110. The correlation function may comprise a mathematical correlation that calculates a probability that the recommendation should be provided as a function of the probability that input data to BJ1 111 has a different profile and the value for a predicted and/or determined magnitude of impact of input data to BJ1 111 having a different profile on batch process 110. If the probability that a recommendation should be provided exceeds a threshold value (e.g., 50%), then RM 105 may provide the recommendation. RM 105 may provide one or more recommendations by iterating over one or more correlation functions in in database 107.

Providing a recommendation may comprise providing a problem record to user 120. For example, system 101 may display information to a user via UIM 106. A problem record may include information stored in database 107 such as one or more performance parameters associated with batch process 110, one or more real-time values monitored by BPMM 103 associated with the one or more performance parameters, one or more deviations between a monitored real-time value and a threshold value associated with a performance parameter associated with the monitored real-time value, one or more predicted and/or detected data quality issues, one or more magnitudes of the one or more predicted and/or detected data quality issues, one or more predicted and/or determined magnitudes of impact of the one or more predicted and/or detected data quality issues, and one or more recommendations for resolving or preventing the one or more predicted and/or detected data quality issues. RM 105 may provide a problem record to user 120 upon receiving a request from user 120 via UIM 106, or provide a persistent display using, for example, a GUI comprising the problem record.

### Calibration

Certain embodiments in accordance with the present disclosure may improve the accuracy of data quality assessment by performing one or more calibrations based on a comparison between actual performance of the batch process and a predicted performance of the batch process. For example, ACM 102 may perform a calibration of system 101 comprising calibration of one or more threshold values associated with the one or more performance parameters associated with one or more batch jobs in batch process 110, one or more correlation functions in correlation information metadata, and/or one or more correlation functions in recommendation information metadata. ACM 102 may perform a calibration when batch process 110 terminates execution.

Calibration of system 101 by ACM 102 may comprise configuring BPMM 103 to track a batch process status comprising one or more batch process status parameters associated with the performance of batch process 110. Batch process status parameters may comprise, for example, an indication that batch process 110 completed successfully or failed to complete successfully, a number of batch jobs that completed successfully or failed to complete successfully during one execution run of batch process 110, a number of failed or successfully completed transactions or operations performed of batch process 110 during one execution of batch process 110, a number of failed or successfully completed transactions or operations performed by a or a batch job in batch process 110 during one execution run of batch process 110, an amount of time (e.g., computing time) required for batch process 110 complete one execution run, etc, BPMM 103 may, for example, determine one or more batch process status parameters at the end of the latest execution run of batch process 110 from the runtime environment of batch process 110 and/or metadata associated with batch process 110, and append the latest determined one or more batch process status parameters to a table of historical batch process status parameters in database 107.

ACM 102 may also project a predicted batch process status comprising one or more projected batch process status parameters based on the table of historical batch process status parameters and/or the table of historical real-time values stored in database 107. ACM 102 may project the predicted batch process status based on a calibration correlation function received by ACM 102 during initialization and/or configuration of system 101. The calibration correlation function may determine the predicted batch process status comprising one or more projected batch process status parameters based on historical batch process status parameters and/or the table of historical real-time values using, for example, a mathematical correlation, a probability density function, and/or a statistical test.

ACM 102 may then calculate a deviation between the one or more projected batch process status parameters and the latest determined one or more batch process parameters stored in database 107. If the calculated deviation exceeds a calibration toleration threshold received by ACM 102 during initialization and/or configuration of system 101, ACM 102 may calibrate one or more threshold values associated with the one or more performance parameters associated with one or more batch jobs in batch process 110, one or more correlation functions in correlation information metadata stored in database 107, and/or one or more correlation functions in recommendation information metadata stored in database 107. For example, ACM 102 may calibrate a correlation function in correlation information stored in database 107 using statistical modeling techniques, e.g., a curve-fitting technique such as a least-squares regression analysis. ACM 102 may also adjust one or more threshold values based on, for example, statistical analysis of one or more corresponding historical real-time values. For example, ACM 102 may adjust a threshold value for a frequency of read/write operations performed by BJ1 111 based on historical real-time values of a frequency of read/write operations performed by obtained by BPMM 103 during previous execution runs of batch process 110.

### Exemplary Computer System

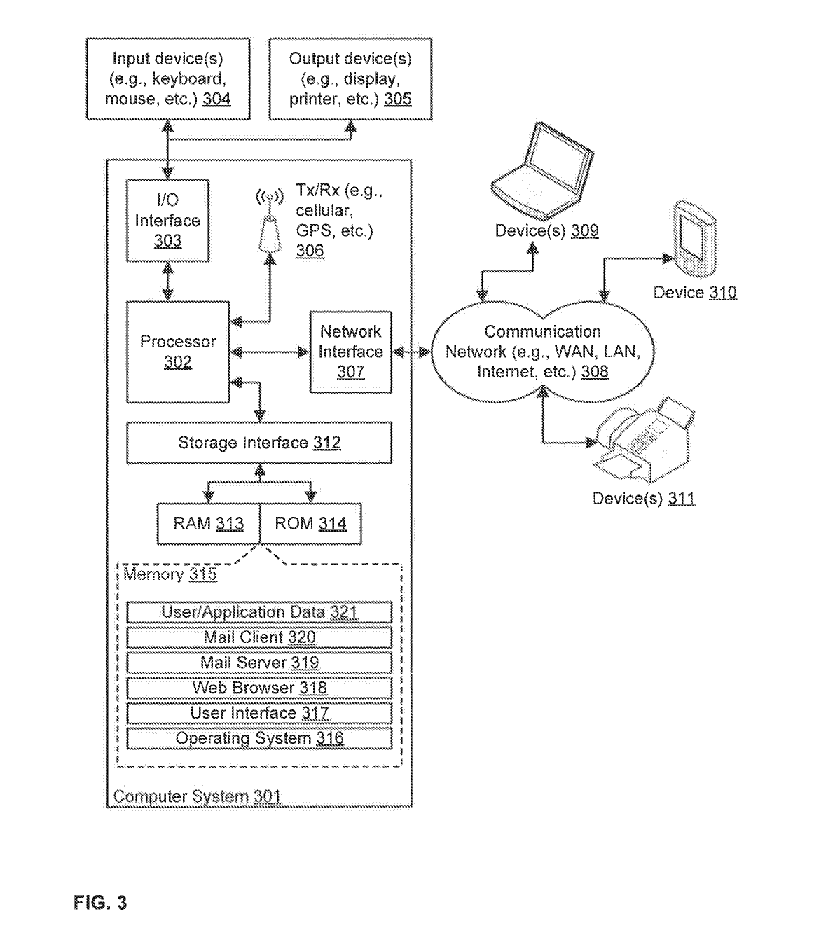

FIG. 3 is a block diagram of an exemplary computer system for implementing embodiments consistent with the present disclosure. Variations of computer system 301 may be used for implementing any of the devices and/or device components presented in this disclosure, including system 101. Computer system 301 may comprise a central processing unit (CPU or processor) 302. Processor 302 may comprise at least one data processor for executing program components for executing user- or system-generated requests. A user may include a person using a device such as such as those included in this disclosure or such a device itself. The processor may include specialized processing units such as integrated system (bus) controllers, memory management control units, floating point units, graphics processing units, digital signal processing units, etc. The processor may include a microprocessor, such as AMD Athlon, Duron or Opteron, ARM's application, embedded or secure processors, IBM PowerPC, Intel's Core, ltanium, Xeon, Celeron or other line of processors, etc. The processor 302 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 302 may be disposed in communication with one or more input/output (I/O) devices via I/O interface 303. The I/O interface 303 may employ communication protocols/methods such as, without limitation, audio, analog, digital, monaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n /b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 303, the computer system 301 may communicate with one or more I/O devices. For example, the input device 304 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, visors, etc. Output device 305 may be a printer, fax machine, video display (e.g., cathode ray tube (CRT), liquid crystal display (LCD), light-emitting diode (LED), plasma, or the like), audio speaker, etc. In some embodiments, a transceiver 306 may be disposed in connection with the processor 302. The transceiver may facilitate various types of wireless transmission or reception. For example, the transceiver may include an antenna operatively connected to a transceiver chip (e.g., Texas Instruments WiLink WL1283, Broadcom BCM4750IUB8, Infineon Technologies X-Gold 618-PMB9800, or the like), providing IEEE 802.11a/b/g/n, Bluetooth, FM, global positioning system (GPS), 2G/3G HSDPA/HSUPA communications, etc.

In some embodiments, the processor 302 may be disposed in communication with a communication network 308 via a network interface 307. The network interface 307 may communicate with the communication network 308. The network interface may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 308 may include, without limitation, a direct interconnection, local area network (LAN), wide area network (WAN), wireless network (e.g., using Wireless Application Protocol), the Internet, etc. Using the network interface 307 and the communication network 308, the computer system 301 may communicate with devices 309. These devices may include, without limitation, personal computer(s), server(s), fax machines, printers, scanners, various mobile devices such as cellular telephones, smartphones (e.g., Apple iPhone, Blackberry, Android-based phones, etc.), tablet computers, eBook readers (Amazon Kindle, Nook, etc.), laptop computers, notebooks, gaming consoles (Microsoft Xbox, Nintendo DS, Sony PlayStation, etc.), or the like. In some embodiments, the computer system 301 may itself embody one or more of these devices.

In some embodiments, the processor 302 may be disposed in communication with one or more memory devices (e.g., RAM 313, ROM 314, etc.) via a storage interface 312. The storage interface may connect to memory devices including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

The memory devices may store a collection of program or database components, including, without limitation, an operating system 316, user interface application 317, web browser 318, mail server 319, mail client 320, user/application data 321 (e.g., any data variables or data records discussed in this disclosure), etc. The operating system 316 may facilitate resource management and operation of the computer system 301. Examples of operating systems include, without limitation, Apple Macintosh OS X, Unix, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/718, etc.), Apple iOS, Google Android, Blackberry OS, or the like. User interface 317 may facilitate display, execution, interaction, manipulation, or operation of program components through textual or graphical facilities. For example, user interfaces may provide computer interaction interface elements on a display system operatively connected to the computer system 301, such as cursors, icons, check boxes, menus, scrollers, windows, widgets, etc. Graphical user interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, Javascript, AJAX, HTML, Adobe Flash, etc.), or the like.

In some embodiments, the computer system 301 may implement a web browser 318 stored program component. The web browser may be a hypertext viewing application, such as Microsoft Internet Explorer, Google Chrome, Mozilla Firefox, Apple Safari, etc. Secure web browsing may be provided using HTTPS (secure hypertext transport protocol), secure sockets layer (SSL), Transport Layer Security (TLS), etc. Web browsers may utilize facilities such as AJAX, DHTML, Adobe Rash, JavaScript, Java, application programming interfaces (APIs), etc. In some embodiments, the computer system 301 may implement a mail server 319 stored program component. The mail server may be an Internet mail server such as Microsoft Exchange, or the like. The mail server may utilize facilities such as ASP, ActiveX, ANSI C++/C#, Microsoft .NET, CGI scripts, Java, JavaScript, PERL, PHP, Python, WebObjects, etc. The mail server may utilize communication protocols such as internet message access protocol (IMAP), messaging application programming interface (MAPI), Microsoft Exchange, post office protocol (POP), simple mail transfer protocol (SMTP), or the like. In some embodiments, the computer system 301 may implement a mail client 320 stored program component. The mail client may be a mail viewing application, such as Apple Mail, Microsoft Entourage, Microsoft Outlook, Mozilla Thunderbird, etc.

In some embodiments, computer system 301 may store user/application data 321, such as the data, variables, records, etc. as described in this disclosure. Such databases may be implemented as fault-tolerant, relational, scalable, secure databases such as Oracle or Sybase. Alternatively, such databases may be implemented using standardized data structures, such as an array, hash, linked list, struct, structured text file (e.g., XML), table, or as object-oriented databases (e.g., using ObjectStore, Poet, Zope, etc.). Such databases may be consolidated or distributed, sometimes among the various computer systems discussed above in this disclosure. It is to be understood that the structure and operation of the any computer or database component may be combined, consolidated, or distributed in any working combination.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method for assessing data quality in a multi-stage, multi-source batch process, the batch process including one or more batch jobs being concurrently executed by one or more hardware processors, the method comprising:
determining, by one or more hardware processors, a performance parameter associated with the one or more batch jobs from a set of batch process parameters based on metadata associated with the batch process;
monitoring a real-time value associated with the performance parameter during execution of the batch process;
calculating a deviation of the monitored real-time value associated with the performance parameter from a threshold value associated with the performance parameter;
predicting, by one or more hardware processors, that one or more data quality issues and a magnitude of the one or more data quality issues are present based on the calculated deviation and a correlation between the calculated deviation and one or more previously identified potential data quality issues;
predicting, by one or more hardware processors, a magnitude of an impact of the one or more predicted data quality issues on the batch process; and
providing, by one or more hardware processors, a recommendation to resolve the one or more predicted data quality issues.

2. The method according to claim 1, wherein the set of batch process parameters includes at least one of: a frequency or number of transactions processed in a logical path within a batch job from among the one or more batch jobs, a number of read/write operations performed by a batch job from among the one or more batch jobs on a dataset; time taken to execute a step within a batch job from among the one or more batch jobs; or a frequency or number of failed transactions within a batch job from among the one or more batch jobs.

3. The method according to claim 1, wherein:
the performance parameter comprises a vector of two or more performance parameters associated with the one or more batch jobs,
monitoring the real-time value associated with the performance parameter during execution of the batch process comprises determining a vector of real-time values associated with the two or more performance parameters, and
calculating a deviation of the monitored real-time value comprises calculating a vector difference between the vector of real-time values and a vector of threshold values associated with the performance parameter.

4. The method according to claim 3, wherein predicting that one or more data quality issues are present comprises making the prediction based on the vector difference and a correlation between the vector difference and one or more previously identified data quality issues.

5. The method according to claim 1, wherein the method further comprises calibrating the threshold value associated with the performance parameter.

6. The method according to claim 5, wherein the method further comprises calibrating the correlation between the calculated deviation and the one or more previously identified data quality issues.

7. The method according to claim 5, wherein calibration occurs when performance of the batch process does not match an expected performance of the batch process.

8. The method according to claim 1, wherein the method further comprises providing an assessment of impacts on the batch process based on the one or more predicted data quality issues and metadata associated with the batch process.

9. The method according to claim 1, further comprising:
receiving, from an authenticated user, at least one of: the set of batch process parameters, the threshold value associated with the performance parameter, or the correlation between the calculated deviation and one or more previously identified potential data quality issues.

10. A system for assessing data quality in a multi-stage, multi-source batch process comprising:
one or more hardware processors; and
a computer-readable medium storing instructions that, when executed by the one or more hardware processors, cause the one or more hardware processors to perform operations comprising:
determining a performance parameter associated with the one or more batch jobs from a set of batch process parameters based on metadata associated with the batch process;
monitoring a real-time value associated with the performance parameter during execution of the batch process;
calculating a deviation of the monitored real-time value associated with the performance parameter from a threshold value associated with the performance parameter;
predicting that one or more data quality issues are present and a magnitude of the one or more data quality issues based on the calculated deviation and a correlation between the calculated deviation and one or more previously identified potential data quality issues;
predicting, by the one or more hardware processors, a magnitude of an impact of the one or more predicted data quality issues on the batch process; and
providing a recommendation to resolve the one or more predicted data quality issues.

11. The system according to claim 10, wherein the set of batch process parameters includes at least one of: a frequency or number of transactions processed in a logical path within a batch job from among the one or more batch jobs, a number of read/write operations performed by a batch job from among the one or more batch jobs on a dataset; time taken to execute a step within a batch job from among the one or more batch jobs; or a frequency or number of failed transactions within a batch job from among the one or more batch jobs.

12. The system according to claim 10, wherein:
the performance parameter comprises a vector of two or more performance parameters associated with the one or more batch jobs,
monitoring the real-time value associated with the performance parameter during execution of the batch process comprises determining a vector of real-time values associated with the two or more performance parameters, and
calculating a deviation of the monitored real-time value comprises calculating a vector difference between the vector of real-time values and a vector of threshold values associated with the performance parameter.

13. The system according to claim 12, wherein predicting that one or more data quality issues are present comprises making the prediction based on the vector difference and a correlation between the vector difference and one or more previously identified data quality issues.

14. The system according to claim 10, wherein the operations further comprise calibrating the threshold value associated with the performance parameter.

15. The system according to claim 14, wherein the operations further comprise calibrating the correlation between the calculated deviation and the one or more previously identified data quality issues.

16. The system according to claim 14, wherein calibration occurs when performance of the batch process does not match an expected performance of the batch process.

17. The system according to claim 10, wherein the operations further comprise providing an assessment of impacts on the batch process based on the one or more predicted data quality issue and metadata associated with the batch process.

18. A non-transitory computer-readable medium storing instructions for assessing data quality in a multi-stage, multi-source batch process, wherein upon execution of the instructions by one or more hardware processors, the hardware processors perform operations comprising;
determining a performance parameter associated with the one or more batch jobs from a set of batch process parameters based on metadata associated with the batch process;
monitoring a real-time value associated with the performance parameter during execution of the batch process;
calculating a deviation of the monitored real-time value associated with the performance parameter from a threshold value associated with the performance parameter;
predicting that one or more data quality issues are present and a magnitude of the one or more data quality issues based on the calculated deviation and a correlation between the calculated deviation and one or more previously identified potential data quality issues;
predicting, by the one or more hardware processors, a magnitude of an impact of the one or more predicted data quality issues on the batch process; and
providing a recommendation to resolve the one or more predicted data quality issues.
